(19) United States
(12) Patent Application Publication
(10) Pub. No.: US 2002/0178439 A1
(43) Pub. Date: Nov. 28, 2002

(54) Method and system for providing a programming interface for loading and saving archives in enterprise applications

(76) Inventors: L. Scott Rich, Apex, NC (US); Ritchard L. Schacher, Apex, NC (US); Tianyu Jiang, Pittsburgh, PA (US)

Correspondence Address: Mark D. Simpson, Synnestvedt & Lechner, 2600 Aramark Tower, 1101 Market Street, Philadelphia, PA, 19107-2950, US

(21) Appl. No.: 09/825,081

(22) Filed: Apr. 2, 2001

(51) Int. Cl. G06F 9/455

(52) U.S. Cl. 717/174

(57) ABSTRACT

The present invention simplifies the tasks that programmers need to carry out to manipulate (e.g., load and save) archives. This is accomplished by providing a common archive interface which is utilized by the programmer to access archive files of varying formats. The common archive interface implements a common set of methods or instructions which the programmer can utilize to manipulate the files, and which automatically and transparently to the programmer loads and saves the files appropriately without regard as to the format (archive or directory) in which the files are stored. The user (programmer) simply utilizes a finite set of simple functions, e.g., “openArchive”, “getDeploymentDescriptor”, “getFiles”, “save”, “extract”, etc. and a “virtual archive containing the requested files is returned to the programmer.

### BACKGROUND OF THE INVENTION

1. Field of the Invention

The present invention relates to the field of computer system interfaces and, more particularly, to interfaces for providing simplified access to enterprise applications on which files are stored in multiple formats, such as archive format and directory-tree format.

2. Description of the Related Art

Modern computing environments frequently deal with large numbers of files, and often they are grouped in the well-known “directory tree” structure. With the recent explosion of networking, it has become common to group together collections of files into one single file to ease the process of transferring these files from one machine on a network to another. These files are referred to as “archives”. Winzip®, by Nico Mak Computing, Inc. is an example of an archive utility program that groups together collections of files into a single file, commonly referred to as a “.zip” file. Programmers skilled in the art are familiar with directory tree structures, archives, archive utilities, and their usage.

The Java 2 Platform Enterprise Edition (J2EE) specification defines a standard architecture which has received widespread industry support and growing customer acceptance, and increased investment focus has been placed on J2EE technology by the industry. In accordance with the Sun J2EE specification, enterprise applications are packaged in an archive file format known as a JAR (Java Archive) file. This standardizes the grouping of the components of an enterprise application in a format which all compliant tools will recognize, for installation/deployment to the application server. The contents of each JAR file consists of a collection of files, some of which also may be JAR files. When an archive file itself, such as a JAR file, also contains archive files, the “second-level” archive files within the “first-level” archive file are called “nested” archive files. Nested JAR files represent “modules” to be deployed on a J2EE application server (eg, Websphere by IBM). A module in the context of J2EE architecture is a specialized kind of JAR file, containing Java classes and a deployment descriptor. A deployment descriptor is a configuration file which contains deployment information instructing the server how to deploy the application.

It is not uncommon for the nested JAR files to themselves contain nested JAR files. An example is a Web ARchive (WAR) file described in the Sun Java Servlet Specification, v2.2, by Sun Microsystems (Dec. 17, 1999). In addition to web pages and other assorted files (e.g., graphics), a WAR file may contain “libraries”, which are JAR files containing compiled programming code to be utilized by the web application.

A J2EE application is packaged using a JAR file format into a file with a “.ear” (Enterprise Archive, or EAR) filename extension. Each EAR file, as well as each nested module (nested JAR) file, contains a collection of files, including deployment or configuration information which must be read and parsed to determine how the application server is to deploy the application. Tool implementations are responsible for providing ways to edit, assemble, and manipulate the contents of all of the above-described archives. J2EE compliant application servers must be able to open these archives and read the contents.

A very simplified example of the structure of an archive file named “MySample.ear” is illustrated below in “Example 1 ”. Indentations represent the contents of an archive:

MySample.ear

| | |
|---|---|
| -META-INF/MANIFEST.MF (zip entry) | [1] |
| -META-INF/application.xml (zip entry) | [2] |
| -ejbJarFile1.jar (nested archive in JAR format) | [3] |
| -META-INF/MANIFEST.MF (zip entry) | [4] |
| -META-INF/ejb-jar.xml (zip entry) | [5] |
| -com/ibm/TestBean.class (zip entry) | [6] |
| -com/ibm/TestHome.class (zip entry) | [7] |
| -com/ibm/TestRemote.class (zip entry) | [8] |
| -warFile1.war (nested archive in WAR format) | [9] |
| -META-INF/MANIFEST.MF (zip entry) | [10] |
| -WEB-INF/web.xml (zip entry) | [11] |
| -WEB-INF/lib/library.jar (nested archive in JAR format) | [12] |
| -META-INF/MANIFEST.MF (zip entry) | [13] |
| -com/ibm/LibClass.class (zip entry) | [14] |
| -MyIcon.gif (zip entry) | [15] |
| -index.html (zip entry) | [16] |

### EXAMPLE 1

Many application server implementations will expand all the nested files of an EAR file when it is installed, in the directory space of a running server, usually for performance reasons, because random access to the contents of an archive within an archive is computationally expensive, and there are not commonly available libraries existing for providing such access efficiently.

Expanding Example 1 (i.e., listing out the nested archive files) might result in a directory tree structure as shown in the following “Example 2”. The plus (+) and hyphen (−) symb9ls are visual cues to differentiate directories from files:

| | |
|---|---|
| +MySample.ear (directory) | [1] |
| +META-INF (directory) | [2] |
| -MANIFEST.MF (file) | [3] |
| -application.xml (file | [4] |
| -ejbJarFile1.jar (unexpanded archive file in JAR format) | [5] |
| -META-INF/MANIFEST.MF (zip entry) | [6] |
| -META-INF/ejb-jar.xml (zip entry) | [7] |
| -com/ibm/TestBean.class (zip entry) | [8] |
| -com/ibm/TestHome.class (zip entry) | [9] |
| -com/ibm/TestRemote.class (zip entry) | [10] |
| +warFile1.war (directory) | [11] |
| +META-INF (directory) | [12] |
| -MANIFEST.MF (file) | [13] |
| +WEB-INF (directory) | [14] |
| -web.xml (file) | [15] |
| -lib (directory) | [16] |
| -library.jar (unexpanded archive file in JAR format) | [17] |
| -META-INF/MANIFEST.MF (zip entry) | [18] |
| -com/ibm/LibClass.class (zip entry) | [19] |
| -MyIcon.gif (file) | [20] |
| -index.html (file) | [21] |

### EXAMPLE 2

The application server implementation will look in a top-level or “root” directory of an installed EAR ([1] in Example 2) for deployment information in the META-INF/application.xml file ([4] in Example 2) and traverse subdirectories for nested module deployment information as in the deployment descriptors of lines [7] and [15] in Example 2. The server may not necessarily expand all the nested archives (see, for example, lines [5] and [17] in Example 2); archives having nested archives may be expanded, but archives having ordinary (non-archive) files only might not be. For example, an EJB JAR file having no nested archives would not be expanded; the aforementioned WAR file, containing library JARs, would be, but the library JARs would not.

Assembly or packaging tools, on the other hand, will usually provide facilities for editing and composing actual JAR files without the need to expand them (as opposed to having to expand the JAR file to a directory tree structure). Nested module files and ordinary files may be added and removed from an EAR file, and nested JAR files and ordinary files may be added and removed from these module files. The assembly tools also provide a means for editing and changing the deployment descriptors to be saved in the archive(s), which will later be installed/deployed on the application server.

The two environments, assembly and “runtime” (the running application server), are therefore dealing with two different physical file structures: assembly, with JARs; and runtime, with a mixture of expanded JARs in a directory tree structure and JAR files themselves. There is much commonality between the two environments, however; specifically the need to load, edit, and save deployment information. What is needed is a library of programming APIs (application programming interface) that can be shared between the two systems so that a user (e.g., a programmer) can load, edit/manipulate, and save files using one set of commands without having to know which structure, archive or directory tree is in use; however, such API's do not exist in the prior art. Lacking such a framework, the runtime implementation must reimplement programs/code for reading and modifying the contents of expanded EAR files that are very similar to code written for assembly environments. This redundancy dramatically increases development time and costs for groups building both assembly tools and an application server. Furthermore, it leads to possible inconsistencies between the two separate frameworks, thus increasing the potential for defects.

The Sun specifications (Java Servlet Specification, v. 2.2; and Java 2 Platform Enterprise Edition Specification v. 1.2) define a standard set of deployment information and the format of such information that must be present in a J2EE archive in order for it to be valid. Many tool/application server vendors (e.g., IBM, Sun MicroSystems), however, commonly add “extensions” to the “base” deployment information. These extensions are data stored in extra files included in the archive. Moreover, the format of the base deployment information often changes from one version of the specification to the next. An example is the Enterpise JavaBeans specification. The format of the “deployment descriptors” changed dramatically from version 1.0 to version 1.1. A tool vendor wishing to support compatibility across versions may provide tools for converting an archive from one version to another.

It is a common scenario that an end user of an assembly tool will want to open an archive file and begin editing it. However, he/she may not be sure which kind of archive the file is (e.g., EJB JAR file, WAR file, EAR file, etc.), which version it is (e.g., 1.0, 1.1), or from which vendor tool the archive was originally produced. This requires the user to utilize “trial and error” until he or she locates the correct program or tool to use to open and edit the file, and this can be tedious, time-consuming, and frustrating to the user.

It would be desirable for the user to be able to invoke a simple “open archive” command (or similar descriptive command) when there is a need to load a file, representing and archive, on which to perform editing operations, and have the tool (rather than the user) discern the format of the archive to be loaded. What is needed therefore is a programmer API that can accomplish this task, and more preferably, in an extendible, “pluggable” framework. In being pluggable, the framework would support the adding of new “converters” or discriminators” for new or unrecognized archive types, new versions, and other vendor extensions. The discriminators would know how to discern the archive type, and how to identify what version it is and possibly from which vendor it was produced by simply defining and implementing an instance of a predefined interface, and adding initialization code at program start-up to register this instance. Without such a framework, end users have to specify the type, version, and possibly original tool at the time the archive is opened in order for the tool to know what to do with it. Such a framework would increase the flexibility of a tool set as support for converting extensions from other vendor formats could be added incrementally.

### SUMMARY OF THE INVENTION

The present invention simplifies the tasks that programmers need to carry out to manipulate (e.g., load and save) archives. This is accomplished by providing a common archive interface which is utilized by the programmer to access archive files of varying formats. The common archive interface implements a common set of methods or instructions which the programmer can utilize to manipulate the files, and which automatically and transparently to the programmer loads and saves the files appropriately without regard as to the format (archive or directory) in which the files are stored. The user (programmer) simply utilizes a finite set of simple functions, e.g., “openArchive”, “getDeploymentDescriptor”, “getFiles”, “save”, “extract”, etc.

In accordance with a preferred embodiment, the present invention is a method for returning files to a user of an enterprise application, comprising the steps of: requesting the loading of a set of one or more files stored under a predetermined file path and name; determining if the requested file set is in an archive format or a directory tree format; creating a loading strategy based on said determination; creating a virtual archive using the loading strategy; and gathering said one or more files in said set, storing them in said virtual archive, and returning said virtual archive to said user.

### BRIEF DESCRIPTION OF THE DRAWINGS

FIG. 1 is a flowchart illustrating a loading process performed in accordance with the present invention;

FIG. 2 is a flowchart illustrating a saving process performed in accordance with the present invention;

FIG. 3 illustrates a representative workstation hardware environment in which the present invention may be practiced; and

FIG. 4 illustrates a data processing network in which the present invention may be practiced.

### DETAILED DESCRIPTION OF THE PREFERRED EMBODIMENTS

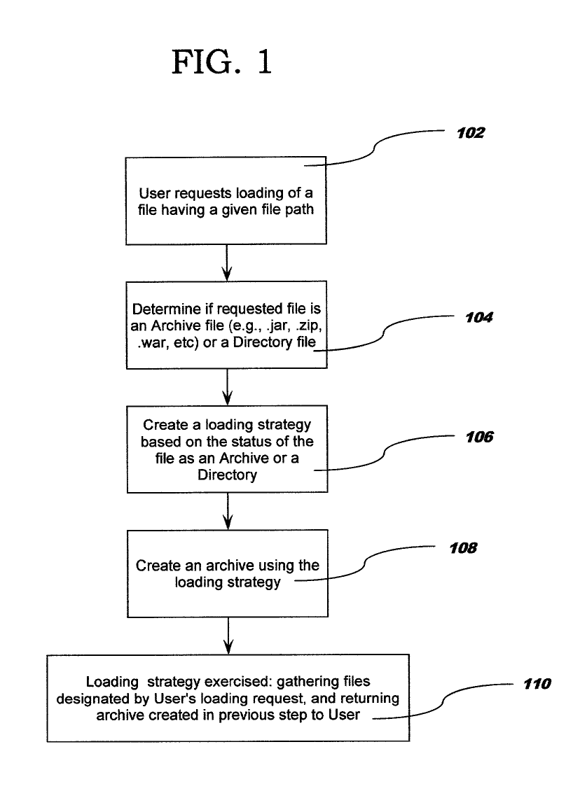

FIG. 1 is a flowchart illustrating the basic steps performed in accordance with the present invention for loading a file. These steps present an example of steps which will implement the present invention. It is understood that the actual implementation of the steps can be implemented in software and the particular software code needed to implement theses steps will vary from programmer to programmer and also depending upon the software language utilized.

At step 102, the user (running program) requests the loading of an archive having a given file path/name. In Example 1, above, the file name would be “MySample.ear” and the path might be C:\temp\samples\. In Example 2 above, the file name would be “MySample.ear” and the path might be C:\temp\ExpandedSamples\.

At step 104, a determination is made if the requested file is an archive file type (e.g., .jar, .zip, .war, etc.) or a directory tree file. Currently available API's exist which can be utilized to make this determination.

At step 106, a loading strategy for loading and displaying the file requested by the user (“open archive” command) is created based on the status of the file requested as having an archive structure or a directory tree. The loading strategy is simply the implementation of a set of methods (either by recursively iterating/visiting the nested files in the case of a directory tree, or by iterating/visiting the zip entries and nested archives in actual archive files in the case of an archive format) to be used in finding the files on the system. These methods may be implemented using known and commonly available APIs.

At step 108, a “virtual” archive to return to the calling method is created based upon the loading strategy. This object is referred to as a “virtual” archive because the data structure returned as a result of invoking the “open archive” operation will be in archive format, even though the file that the user requested to open was in a directory tree structure. Finally, at step 110, the loading strategy that has been created is exercised. This involves gathering the files designated by the user's loading request (programatic invocation of a getFiles()command), formatting them into the virtual archive format, and returning the list to the calling method (a method is defined as a programming function that can be executed in a running program).

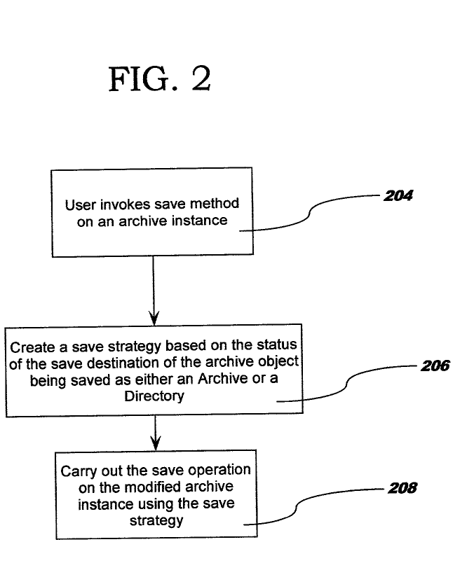

FIG. 2 illustrates a saving process in accordance with the present invention. As with the discussion of FIG. 1, these steps present an example of steps which will implement the present invention. It is understood that the actual implementation of the steps can be implemented in software and the particular software code needed to implement theses steps will vary from programmer to programmer and also depending upon the software language utilized.

Referring to FIG. 2, at step 202, the user requests the saving of a file under a given path/file name, either by using one of a number of predefined “convenience” methods which will create a particular strategy for saving the archive, or by using a custom-implemented stategy defined by the user (programmer). Examples of predefined methods include “save” and “saveAs”, which by default would save the archive using a strategy for a JAR file, or “extract” and “extractTo”, which by default would save the archive using a strategy for an expanded directory structure.

An example of a “custom” strategy that the user might implement could include a strategy for saving the contents of the archive to a remote server on a network. The custom strategy must conform to the interface load strategy. In accordance with the present invention, the user can execute simple commands that will carry out the task of saving the archive in the desired form.

At step 206, a save strategy is created from the convenience method based upon the status of the save destination of the virtual archive object being saved, as either an archive or a directory. At step 208, the save operation is carried out on the modified virtual archive object using the save strategy created in step 206.

The following examples of processing requests and the results of executing the requests are given for purposes of example only. It is understood that the file structures illustrated are simplified versions of actual file structures which might contain hundreds or thousands of files, and that the processing requests illustrated contain only the elements needed for explanation and exclude conventional programming codes which are not needed for their explanation.

Referring to Example 1 above, a programmer issues a request to open the archive MySample.ear located at c:\temp\sample\ and obtains a list of the files in the archive:

EARFile archive=openArchive(“C:\\temp\\samples\\MySample.ear”);

List files=archive.getFiles()

The list displayed to the programmer will, in this example, contain 4 elements, as follows. The quotes indicate the URI of the element in the list, and the parenthesized term indicates the object type of the element:

“META-INF/MANIFEST.MF” (File) [1]

“META-INF/application.xml” (File) [2]

“ejbJarFile1.jar” ( a nested JAR file) [3]

“warFile1.war” (a nested WAR file) [4]

### EXAMPLE 3

Next, the programmer desires to retrieve the nested archive file “ejbJarFile1.jar”, and “get” (list) its listing of files:

Archive element=(Archive)archive.getFile(“ejbJarFile1.jar”);

List nestedArchiveFiles=element.getFiles()

The list nestedArchiveFiles would contain 5 elements, and would appear as follows:

“META-INF/MANIFEST.MF” (File) [1]

“META-INF/ejb-jar.xml” (File) [2]

“com/ibm/TestBean.class” (File) [3]

“com/ibm/TestHome.class” (File) [4]

“com/ibm/TestRemote.class” (File) [5]

### EXAMPLE 4

Repeating the above routine for the WAR file would be as follows:

Archive element=(Archive)archive.getFile(“warFile1.war”);

List nestedArchiveFiles=element).getFiles()

and result in the following:

“META-INF/MANIFEST.MF” (File) [1]

“WEB-INF/web.xml” (File) [2]

“WEB-INF/lib/library.jar” (Archive) [3]

“Mylcon.gif” (File) [4]

“index.html” (File) [5]

### EXAMPLE 5

The above example usages demonstrate how a client of this invention, a programmer building a system that works with archives, would enumerate the files in a top-level archive, as well as the files in nested archives contained within the top-level archive, and how the data would conceptually be returned.

Referring now to Example 2 (exapanded directory tree, with archive files contained therein), presume that the file “MySample.ear” exists in the C:\temp\ExpandedSamples\\directory, and that this file is also a directory. The first programmer issues a request to open the archive with the following code:

EARFile archive=openArchive(“C:\\temp\\ExpandedSamples\\MySample.ear”);

List files=archives.getFiles (MySampleExpanded.ear)

In this case, the string parameter represents the path to a directory, as opposed to a JAR file in the first example; however, it should be noted that the command structure is identical.

Invoking the aforementioned operations will net the exact same results as with the archive example discussed above with respect to Examples 1-5. The expanded directory tree structure and the ear file on disk are functionally equivalent in terms of what invocation of the methods returns; the programmer obtains the same results not knowing that the actions on the archive files and/or on the directory tree files required different processing methods of obtain the same apparent result. The directory load strategy builds the file lists exactly as they were built for the ear file in the first example.

The present invention thus comprises an interface that determines which kind of file (Archive or Directory Tree) is being accessed (loaded) and then automatically and transparently (to the user/programmer) provides access to and from the files; a “virtual archive” is created which gives the user/programmer a list of proxies which will help “find” the files requested. The user/programmer uses a “generalized” command (e.g. “OpenArchive (path/name)) and then known techniques are utilized to determine if the request is asking for an archive format or directory tree format; then a strategy is developed based on this determination and the strategy causes the correct format be used to load the files; and the list is provided to the user/programmer in an “expected” format (e.g., Archive format) regardless of what format it actually takes. There are numerous known API's (e.g., “java.util.zip” and “java.io”) that can be utilized to perform the determining steps previously described.

In a preferred embodiment, the implementation of the load strategies will employ “lazy” programming techniques for building the list of files in an archive. That is, execution of the task of enumerating the list of files in an archive will not occur until a “getFiles” method is invoked on the archive, at some unknown time after the archive is opened. The same applies to nested archives within archives. This is an optimazation that allows an archive to be opened and discriminated with minimal processing, thus improving response time for programs using the invention.

In an alternative preferred embodiment, “File” objects can be added to, removed from, and copied between “Archives”, and the execution of the task of copying the contents is deferred until a save function is invoked.

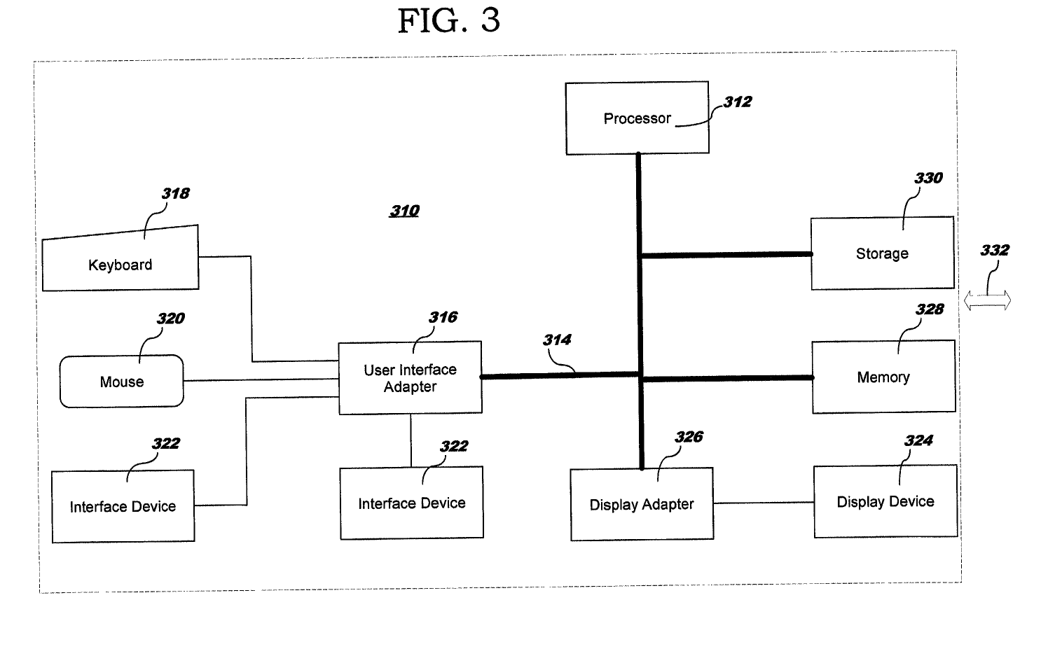

The present invention is designed for operation in a typical computer environment including singles stand-alone workstations, local are networks, wide are networks, mainframes, etc. FIG. 3 illustrates a representative workstation hardware environment in which the present invention may be practiced. The environment of FIG. 3 comprises a representative single user computer workstation 300, such as a personal computer, including related peripheral devices. The workstation 300 includes a microprocessor 312 and a bus 314 employed to connect and enable communication between the microprocessor 312 and the components of the workstation 300 in accordance with known techniques. The workstation 300 typically includes a user interface adapter 316, which connects the microprocessor 312 via the bus 314 to one or more interface devices, such as keyboard 318, mouse 320, and/or other interface devices 322, which can be any user interface device, such as a touch sensitive screen, digitized entry pad, etc. The bus 314 also connects a display device 324, such as an LCD screen or monitor, to the microprocessor 312 via a display adapter 326. The bus 314 also connects the microprocessor 312 to memory 328 and long term storage 330 which can include a hard drive, tape drive, etc.

The workstation 300 communicates via a communications channel 332 with other computers or networks of computers. The workstation 300 may be associated with such other computers in a local area network (LAN) or a wide area network (WAN), or the workstation 300 can be client in a client/server arrangement with another computer, etc. All of these configurations, as well as the appropriate communications hardware and software, are known in the art.

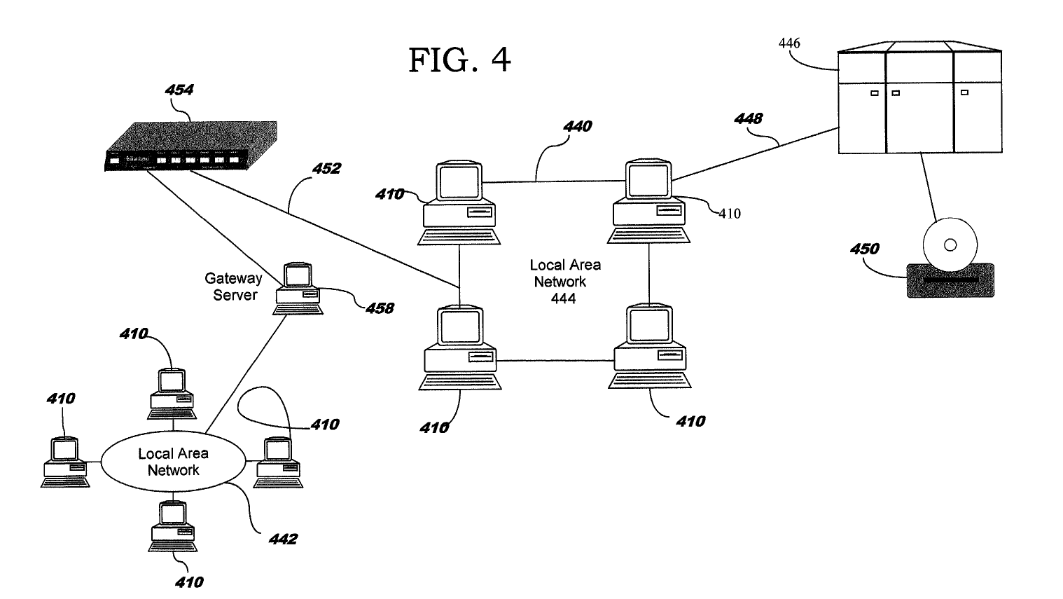

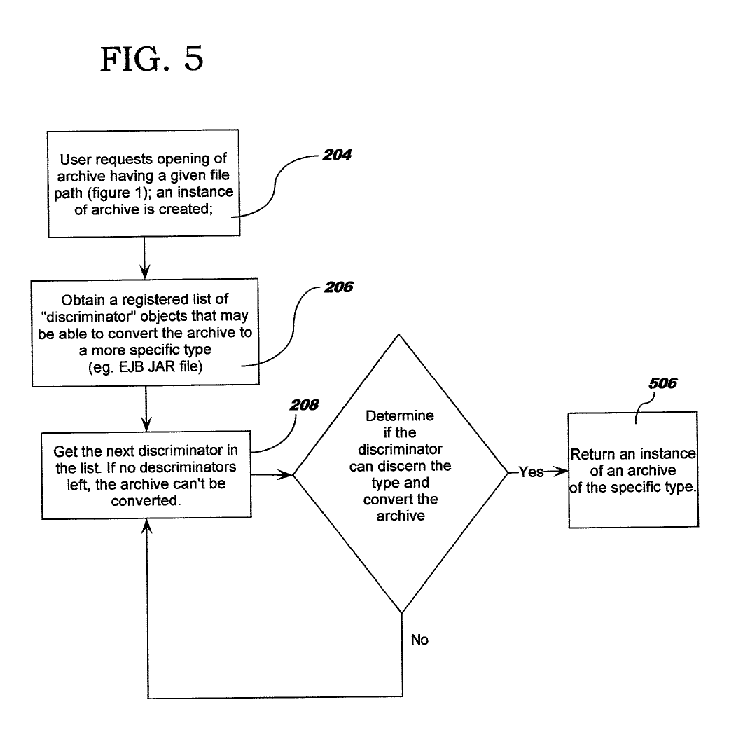

FIG. 4 illustrates a data processing network 440 in which the present invention may be practiced. The data processing network 440 includes a plurality of individual networks, including LANs 442 and 444, each of which includes a plurality of individual workstations 300. Alternatively, as those skilled in the art will appreciate, a LAN may comprise a plurality of intelligent workstations coupled to a host processor.

Still referring to FIG. 4, the data processing network 440 may also include multiple mainframe computers, such as a mainframe computer 446, which may be preferably coupled to the LAN 444 by means of a communications link 448. The mainframe computer 446 may be implemented utilizing an Enterprise Systems Architecture/370, or an Enterprise Systems Architecture/390 computer available from the International Business Machines Corporation (IBM). Depending on the application, a midrange computer, such as an Application System/400 (also known as an AS/400) may be employed. “Enterprise Systems Architecture/370” is a trademark of IBM; “Enterprise Systems Architecture/390”, “Application System/400” and “AS/400” are registered trademarks of IBM.

The mainframe computer 446 may also be coupled to a storage device 450, which may serve as remote storage for the LAN 444. Similarly, the LAN 444 may be coupled to a communications link 452 through a subsystem control unit/communication controller 454 and a communications link 456 to a gateway server 458. The gateway server 458 is preferably an individual computer or intelligent workstation which serves to link the LAN 442 to the LAN 444.

Those skilled in the art will appreciate that the mainframe computer 446 may be located a great geographic distance from the LAN 444, and similarly, the LAN 444 may be located a substantial distance from the LAN 442. For example, the LAN 442 may be located in California, while the LAN 444 may be located in Texas, and the mainframe computer 446 may be located in New York.

Software programming code which embodies the present invention is typically stored in permanent storage of some type, such as the permanent storage 330 of the workstation 300. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Using the present invention greatly simplifies the task of the programmer/user. For example, the programmer/user is shielded from the implementation details of opening or saving, regardless of whether the file is an archive file or a directory tree file, or a directory tree file with a combination of files and nested archive files, or an archive file with nested files. Further, the “results” of the commands (the file list that is returned, and possibly manipulated, by the programmer/user) is, in the preferred embodiment, in a data structure which models the archive format, which format is familiar to most programmers, and is easier to understand than traversing directories and subdirectories.

FIG. 5 is a flowchart illustrating the process of discriminating and converting an archive performed in accordance with the present invention. Referring to FIG. 5, at step 502, the user (running program) requests the opening of an archive having a given file path/name. In accordance with the steps illustrated in FIG. 1, an instance of an archive is created.

At step 503, the system retrieves and ordered list of registered objects that conform to the discriminator interface. At step 504, the system iterates through the list of discriminators. At step 505 and 506, the system tests to determine if a given discriminator is able to recognize an archive. If it can, than in “import” method is invoked using the discriminator, which will create a new instance of a more specific archive type (e.g., an EJB JAR file).

Steps 504 and 505 are repeated until an archive has been converted or all of the discriminators have been tested. In a preferred embodiment, a programmer would be able to register new implementation of the discriminator interface, and control the order in the registered list in which the discriminator is registered.

Using an interface for “discriminator objects”, that can be implemented, extended, and added by the programmer, greatly increases the flexibility of an archive editing tool to convert “meta-data” (data which describes the data in an archive), in the form of that required by specifications or in the form of vendor extensions, to a form that can be recognized by the tool. It allows new types of discriminators to be incrementally added to the system as new types of archives are defined in future vesions of the specifications, and as support for converting archives produced by other vendors is added to the tool.

Although the present invention has been described with respect to a specific preferred embodiment thereof, various changes and modifications may be suggested to one skilled in the art. For example, while the above examples refer to the return of files to the programmer/user in an archive format, and only two basic file formats, archive and directory formats, are given as examples, it is understood that the present invention is not so limited. More specifically, the present inventions can be utilized in connections with any known file formats, and the files can be returned to the programmer/user in any format that is desired by the programmer designing an interface in accordance with the present invention. It is intended that the present invention encompass such changes and modifications as fall within the scope of the appended claims.

We claim:

1. A method for returning files to a user of an enterprise application, comrprising the steps of:
requesting the loading of a set of one or more files stored under a predetermined file path and name;
determining if the requested file set is in an archive format or a directory tree format;
creating a loading strategy based on said determination;
creating a virtual archive using the loading strategy; and
gathering said one or more files in said set, storing them in said virtual archive, and returning said virtual archive to said user.
